(19) United States
(12) Patent Application Publication
(10) Pub. No.: US 2010/0299349 A1
(43) Pub. Date: Nov. 25, 2010

(54) Reducing Latency in Returning Online Search Results

(75) Inventors: Albert Gordon Greenberg, Seattle, WA (US); Lihua Yuan, Redmond, WA (US); Randall Friend Kern, Seattle, WA (US); Jitendra Dattatraya Padhye, Redmond, WA (US); David A. Maltz, Bellevue, WA (US); Parveen Kumar Patel, Redmond, WA (US); Murari Sridharan, Sammamish, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/469,160

(22) Filed: May 20, 2009

(51) Int. Cl. G06F 17/30; H04L 12/56

(52) U.S. Cl. 707/769; 370/235; 707/803; 707/770

(57) ABSTRACT

An embodiment of the invention is directed to reducing search-response latency. The closest intermediate server can be located between a client computing device and a search engine. A search query is sent to the intermediate server in a first packet of a transport protocol handshake. A plurality of packets are received from the intermediate server. The plurality of packets are used to open a window associated with a transport protocol. A response related to the search query is received by the client.

### INTRODUCTION

The Internet enables information to be distributed across a large number of websites. Search engines enable locating information accessible via the Internet. Latency is a measure of the time between when a search query is sent by a client computing device and a response is received by that client computing device.

### SUMMARY

This Summary is generally provided to introduce the reader to one or more select concepts described below in the Detailed Description in a simplified form. This Summary is not intended to identify the invention or even key features, which is the purview of claims below, but is provided to meet patent-related regulation requirements.

One embodiment of the invention includes a method of reducing search-response latency. A closest intermediate server is determined. The closest intermediate server can be located between a client computing device and a search engine. A search query is sent to the intermediate server in a first packet of a transport protocol handshake. A plurality of packets are received from the intermediate server. The plurality of packets are used to open a window associated with a transport protocol. A response related to the search query is received by the client.

### BRIEF DESCRIPTION OF THE DRAWING

Illustrative embodiments of the present invention are described in detail below with reference to the attached drawing figures, and wherein:

FIG. 1 is a block diagram depicting an exemplary computing device;

FIG. 2 is a block diagram depicting a network suitable for implementing embodiments of the invention;

FIG. 3 is a block diagram depicting data flow between a client, intermediate server, and search engine, in accordance with an embodiment of the invention;

FIG. 4 is a flow diagram depicting a method of reducing search-response latency in accordance with an embodiment of the invention;

FIG. 5 is a flow diagram depicting a method of reducing search-response latency in accordance with an embodiment of the invention; and

FIG. 6 is a flow diagram depicting a method of reducing search-response latency in accordance with an embodiment of the invention.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

Embodiments of the present invention provide a way to reduce the latency between the time a query is sent to a server and a response is received at the client issuing the query. By way of example, the query could be a search query issued to a search engine and the response could be a response to the search query. Search queries can include a number of different types of searches. By way of example, a search query could be related to a map search, a video search, and a search for an instant answer. The query may be a text-based query or contain other formats of query terms (e.g., an image). As another example, the query could be queries directed to a web server. Generally, latency can be related to the time information is in transit between to endpoints in a path through a network. A number of factors can affect the latency, including the distance between the endpoints, the number of intermediate nodes between the endpoints, buffer sizes on the intermediate nodes between the endpoints, congestion in the network, and a number of transport protocol layer factors.

Transport protocols have a number of functions that may be performed that could affect latency. Congestion control mechanisms attempt to avoid an excessive amount of data being transmitted through one or more intermediate nodes or links in a path, as this could result in congestion. Reliability mechanisms attempt to recover from network errors due to a variety of causes, for example, packet drops due to buffer overflows at intermediate nodes or transmission errors. By way of example, one common transport protocol having both reliability and congestion control mechanisms is called the Transmission Control Protocol (TCP) and is one of the primary transport protocols used for traffic on the Internet.

TCP uses window-based congestion control and window-based reliability recovery. A window-based algorithm defines a maximum window of data that can be in flight between two endpoints at any given time. For example, if the protocol is using a window size of 1,500 bytes, then the sender can send at most 1,500 bytes of data before receiving an acknowledgement that the data has been received by the receiver. However, the amount of time it takes to receive such an acknowledgement is proportional to the distance between the nodes (the time it takes for one byte of information to pass from one endpoint to another and back is referred to as the Round-Trip Time (RTT). If the window size is too small, the sender may spend the majority of its time waiting for acknowledgements without sending any data. Additionally, TCP requires a three packet handshake before data transfer begins. These packets are sent one at a time, therefore, more than a RTT must pass before data is sent placing a minimum latency on any query being transmitted using TCP.

Additional latency is encountered in the face of losses. First, when a loss is encountered, TCP will retransmit the packet and eventually stop sending any other data until the lost data is received (at most a window of data past the first lost data will be in flight in the common case). In addition to retransmitting the lost data, the sending window size will be reduced in the face of an encountered loss, reducing the amount of data that can be in flight and potentially adding to the latency of new data being received.

Embodiments of the invention combine a number of techniques to reduce the latency between a client sending a search query and receiving a response. Intermediate servers could be used to receive requests from the client computing devices and forward them to the search engines. The intermediate servers could receive the response from the search engines and forward the response on to the client computing device. Through the use of intermediate servers, error handling can be done closer to the client device, and more rapidly, reducing the latency caused by such error. Data can be cached near the client computing device further reducing the latency involved with communicating with the search engine.

Locating intermediate servers could be done in a number of ways. For example, the Domain Name Service (DNS) system could be used to locate an appropriate intermediate server. The DNS system could be augmented with geographic location information. When a request for a server is received, the DNS server could first determine geographic information related to the client device based on the client device's address. The DNS server could then return the address of an intermediate server that is near to the client computing device.

Data could be transmitted in the handshake packets of the transport protocol. This would eliminate the need to wait for the handshake to complete before any data is sent. This technique would allow small queries, such as search queries to be contained in the packets used in the handshake. By way of example, the first handshake packet for TCP is called a SYN packet. The client device could send data related to the search query in the SYN packet. Additionally, this technique could be used between the intermediate server and the search engine. The second packet in the TCP handshake is called a SYN-ACK packet. This packet is sent in response to the SYN packet. Data could similarly be sent in the packet used to carry the SYN-ACK. For example, if the search engine received the search query in the SYN packet, the search engine could immediate start streaming data back in the SYN-ACK packet. The combined mechanism would save at least 1 RTTs.

The initial window size of the transport protocol could be enlarged at the search engine. This would allow the search engine to transmit the entire response, or a significant portion of it without having to wait for any acknowledgements, reducing the latency. Additionally, the initial window size of the intermediate server could be enlarged for the same purpose.

Key packets could be transmitted multiple times. For example, SYN and SYN-ACK packets could be transmitted multiple times. Losses of these key packets can cause a significant loss of performance for transport protocols. Repeating key packets can reduce the probability of their loss.

Forward error correction could be used to attempt to reduce the impact of loss on latency for the transport protocol. For example, forward error correction data allows one or more packets of a group of packets to be rebuilt based on data received in the rest of the packets in the group. The use of forward error correction reduces the need to wait for retransmission to occur, thereby reducing latency.

Window-based congestion control can also result in higher latency when the congestion window is small, for the reasons discussed above. Constantly sending data can keep the congestion window open (at a larger size). Therefore, during times when no data is being sent, for example, when the search engine is processing the query, repeat data, or useless data could be sent to open the congestion window. When the search engine is ready to transmit a response to the search query, the congestion window will already be open, allowing a reduction in the latency for the response to be achieved.

According to some embodiments of the invention, one or more of the above mentioned techniques could be employed either alone or in combination to reduce latency involving transactional communication. For example, a search query and search response is an example of suitable transactional communication. There are other examples, such as web transactions using Asynchronous JavaScript and XML for which embodiments of the invention could be employed to reduce associated latency.

An embodiment of the invention is directed to reducing search-response latency. The closest intermediate server can be located between a client computing device and a search engine. There are a number of ways an intermediate server could be determined to be between a client and a search engine. By way of example, the intermediate server could be located such that the latency from the client computing device and the intermediate server is less than or equal to the latency between the client computing device and the search engine. A search query is sent to the intermediate server in a first packet of a transport protocol handshake. A plurality of packets are received from the intermediate server. The plurality of packets are used to open a window associated with a transport protocol. A response related to the search query is received by the client.

Another embodiment of the invention is directed to reducing search-response latency. A search query from a client computing device is received. The search query is sent to a search engine using a first transport protocol. The search query is contained in a first packet of a transport protocol handshake. A plurality of packets is sent to the client. The plurality of packets are used to open a sending window of a second transport protocol. A response related to the search query is received from the search engine. The response is sent to the client.

A further embodiment of the invention is directed to reducing search-response latency. The closest intermediate server can be located between a client computing device and a search engine. An initial window size related to a transport protocol is increased. A search query is sent to the intermediate server in a first packet of a transport protocol handshake. The first packet of the transport protocol is sent a number of times. A plurality of packets are received from the intermediate server. The plurality of packets are used to open a window associated with a transport protocol. A response related to the search query is received by the client. The response includes a response related to the search query and forward error correction data.

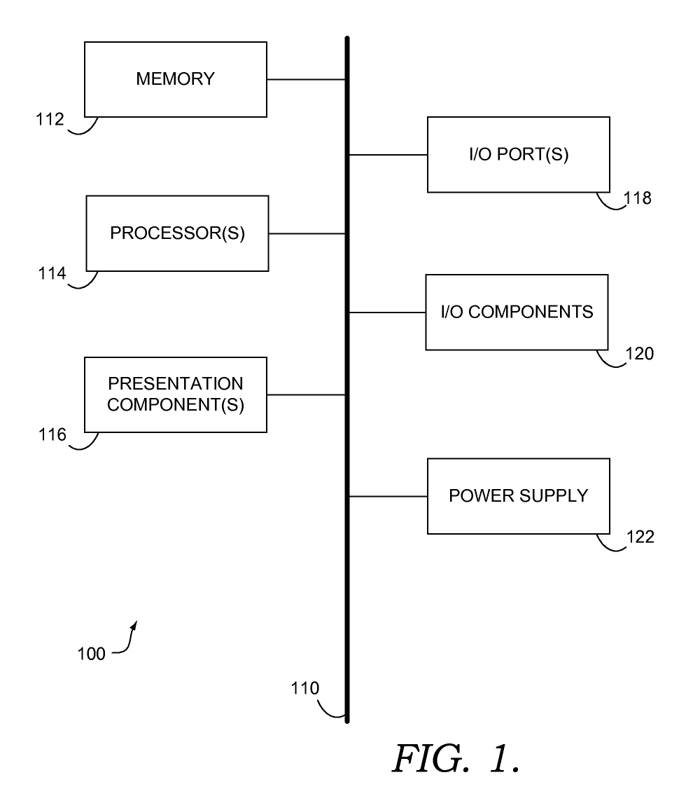

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be practiced in a variety of system configurations, including handheld devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, many processors have memory. We recognize that such is the nature of the art and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. Computer-readable media can be any available media that can be accessed by computing device 100 and include both volatile and nonvolatile media, removable and nonremovable media. By way of example, and not limitation, computer-readable media may include computer storage media and communication media. Computer storage media include both volatile and nonvolatile, removable and nonremovable media implemented in any method or technology for storage of information such as computer-readable instructions, data structures, program modules, or other data. Computer storage media include, but are not limited to, Random-Access Memory (RAM); Read-Only Memory (ROM); Electrically-Erasable, Programmable, Read-Only Memory (EEPROM); flash memory or other memory technology; Compact Disk, Read-Only Memory (CD-ROM); digital versatile disks (DVD) or other optical disk storage; magnetic cassettes; magnetic tape; magnetic disk storage or other magnetic storage devices; or any other medium which can be used to store the desired information and which can be accessed by computing device 100.

Memory 112 includes computer-storage media in the form of volatile memory. Exemplary hardware devices include solid-state memory, such as RAM. Memory 112 includes computer-storage media in the form of nonvolatile memory. The memory 112 may be removable, nonremovable, or a combination thereof. Exemplary hardware devices include solid-state memory, hard drives, optical-disc drives, etc. Computing device 100 includes one or more processors 114 that read data from various entities such as memory 112 or I/O components 120. I/O components 120 present data indications to a user or other device. Exemplary output components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

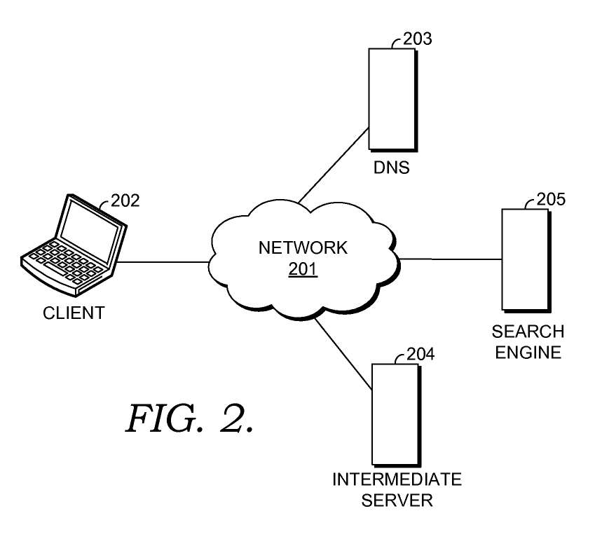

Turning now to FIG. 2, a network suitable for supporting embodiments of the invention is depicted. A client computing device 202 is connected to a network 201 via a suitable network connection. The network 201 could be the Internet or an intranet related to a company, home, or other community. Also attached to the network 201 are a DNS server 203, a search engine 205, and an intermediate server 204. Upon forming a search query, the client computing device 202 could request an appropriate search engine from the DNS server 203. The DNS server 203 could either return the address of the search engine 205 or an intermediate server 204 located closer to the client computing device 202 than the search engine 205 is. The DNS server 203 could use a number of different metrics to determine that an intermediate server 204 is closest. For example, geographic proximity could be used to measure closeness. As another example, network metrics such as latency could be used to measure closeness.

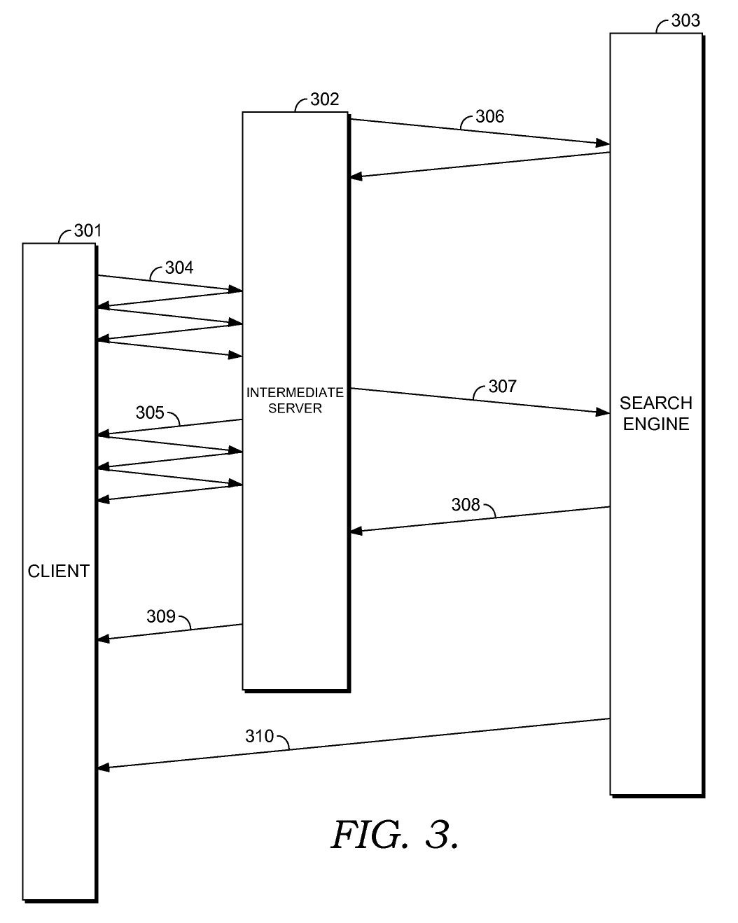

Turning now to FIG. 3, an example search query transaction is depicted. A client computing device 301 uses a intermediate server 302 to make a search query. According to an embodiment of the invention, the intermediate server 302 could monitor the bandwidth and latency between itself and a search engine 303 using packets periodically sent 306 before a search query is initiated. The client 301 could send a search query to the intermediate server 302 using one or more packet transmissions 304. A number of different mechanisms could be used to improve the performance of the initial search query being sent. For example, the search query could be included in the SYN packet of a transport protocol. The intermediate server 302 forwards 307 the search query to the search engine 303. A number of mechanism could be used to improve the performance of the forwarding 307, for example, the search query could be inserted into a SYN packet of a transport protocol. As another example, the search query could be sent using an already existing transport protocol connection. As a further example, the search query could be sent using a larger initial window size.

While the search engine 303 is processing the search query, the intermediate server 302 could send packets 305 to the client 301. According to an embodiment, the packets could contain random data. According to another embodiment, the packets could contain data previously sent. According to a further embodiment, the packets could contain other data that the client can ignore. These packets could be used to keep the transport protocol window open. The search engine 303 sends the response to the search query 308 to the intermediate server 302. According to an embodiment of the invention, the response could be sent in a SYN-ACK packet. According to another embodiment of the invention, the response could be sent using a previously existing transport protocol connection. According to a further embodiment, the response could be sent in a SYN packet of a new transport protocol connection. The intermediate server 302 forwards the response to the search query 309 to the client 301. According to an embodiment of the invention, the response could be sent utilizing the connection with the open window that was maintained by packets 305. According to a further embodiment of the invention, the search engine 303 could transmit the response to the search query 310 directly to the client 301. For example the search engine 303 could reconstruct the connection maintained by the intermediate server 302 with the client 301, which had a window opened through the use of packets 305. The search engine 303 could then transmit the response via this reconstructed connection.

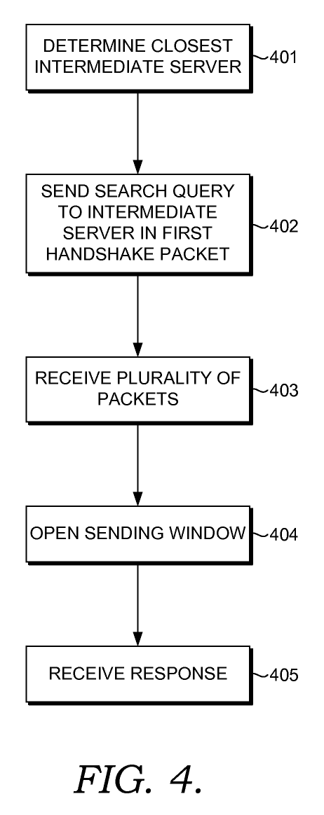

Turning now to FIG. 4, a flow diagram depicting a method of reducing search-response latency is given. A closest intermediate server is determined, as shown at block 401. The intermediate server should be located between the client computing device and a search engine that could be used to determine a response to the search query. An appropriate intermediate server could be one where the latency between the intermediate server and the client computing device is less than or equal to the latency between the search engine and the client computing device. According to an embodiment, the intermediate server could be co-located with the search engine. When more than one appropriate intermediate server is located, a number of factors could be used to choose one. For example, a random number could be used, the load on each of the servers could be used, and the sum of the latency between the client computing device and the intermediate server with the latency between the intermediate server and the search engine could be used. According to an embodiment of the invention, the closest intermediate server could be determined through the use of a DNS server that is augmented to use location information in returning the address of a server. For example the DNS server could sue a geographic-based proximity algorithm to determine the closest intermediate server based on the Internet Protocol addresses of the client, a number of potential servers, and the search engine. A search query is sent to the intermediate server in a first packet of a transport protocol handshake, as shown at block 402. By way of example, the first packet could be the SYN packet of TCP. Sending the search query could include increasing an initial window size of the transport protocol. According to another embodiment of the invention, the first packet of the transport protocol could be sent a number of times. For example, the first packet of the transport protocol could be sent two times.

A plurality of packets is received, as shown at block 403. According to an embodiment of the invention, the plurality of packets could contain random data. According to another embodiment of the invention, the plurality of packets could contain data previously sent. By way of example, the previously sent data could be responses to previous search queries. The plurality of packets are used to open the transport protocol window, as shown at block 404. A response related to the search query is received, as shown at block 405. According to an embodiment of the invention, the response could include a response to the search query and forward error correction data. According to another embodiment of the invention, the response could be received from the intermediate server. According to a further embodiment of the invention, the response could be received directly from the search engine.

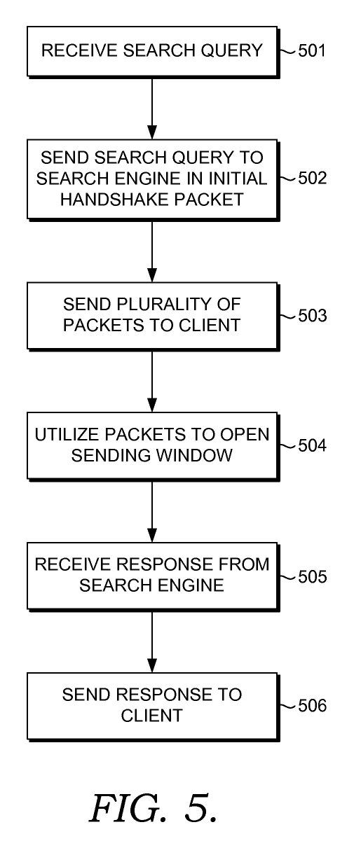

Turning now to FIG. 5, a flow diagram depicting a method of reducing search-response latency is given. A search query is received, as shown at block 501. According to an embodiment of the invention, the search query could be received in the first packet of the handshake of a transport protocol. The search query is sent to a search engine in the first packet of the handshake of a transport protocol, as shown at block 502. According to an embodiment of the invention, the search query received from a client is forwarded to the search engine. According to a further embodiment of the invention, the first packet of the transport protocol could be sent a number of times. By way of example, the first packet could be sent two times.

A plurality of packets are sent to the client, as shown at block 503. According to an embodiment of the invention, the plurality of packets are used to open a sending window of a transport protocol. According to a further embodiment of the invention, the plurality of packets could contain responses to search queries previously sent to the client. The plurality of packets are used to open a sending window, as shown at block 504.

A response related to the search query is received, as shown at block 505. The response could be received in the second packet of a handshake protocol. According to an embodiment of the invention, the second packet of the handshake could be received a number of times. For example the second packet could be received two times. According to another embodiment of the invention, the response could include a response to the search query and forward error correction data. The response related to the search query is sent to the client, as shown at block 506. The response could be sent using the connection with the previously opened window in block 504.

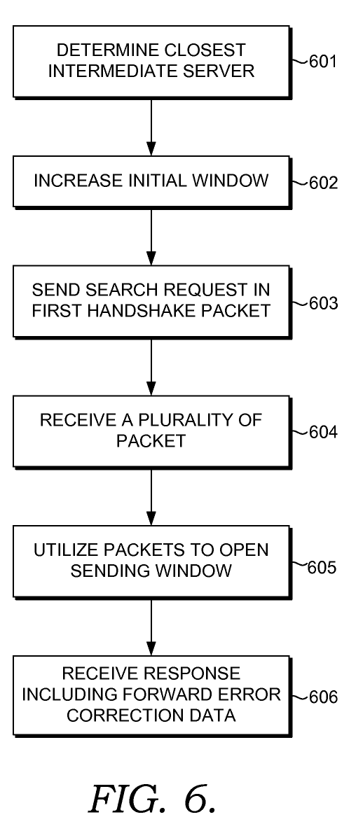

Turning now to FIG. 6, a flow diagram depicting a method of reducing search-response latency is given. A closest intermediate server is determined, as shown at block 601, similar to block 401 of FIG. 4. The initial window size of a transport protocol is increased, as shown at block 602. By way of example, the window size could be double from the standard initial window size. A search query is sent in the initial packet of a handshake protocol, as shown at block 603. According an embodiment of the invention, the initial packet could be sent multiple times. For example, the initial packet could be sent two times.

A plurality of packets are received, as shown at block 604. The plurality of packets could contain random data. The plurality of packets could contain data previously sent. For example, the previously sent data could be previously sent responses to search queries. The plurality of packets are used to open a window associated with a transport protocol, as shown at block 605. For example, the plurality of packets could be used to open a sending window of a transport protocol. A response related to the search query is received from the intermediate server, as shown at block 606. According to an embodiment of the invention, the response includes a response related to the search query and forward error correction data.

Alternative embodiments and implementations of the present invention will become apparent to those skilled in the art to which it pertains upon review of the specification, including the drawing figures. Accordingly, the scope of the present invention is defined by the claims that appear in the “claims” section of this document, rather than the foregoing description.

The invention claimed is:

1. Computer-readable media having computer-executable instructions embodied thereon that, when executed, perform a method of reducing search-response latency, the method comprising:
determining a closest intermediate server, which is positioned between a client computing device (“client”) and a destination server;
sending a search query to the closest intermediate server;
receiving a plurality of packets from the closest intermediate server;
increasing a congestion window of the transport protocol; and
receiving a response related to the search query.

2. The media of claim 1, wherein determining the closest intermediate server includes requesting an address of a closest intermediate server from a domain name service utilizing a geographic-based proximity algorithm.

3. The media of claim 1, wherein increasing a congestion window includes sending a second plurality of packets, wherein said second plurality of packets are utilized to increase the congestion window.

4. The media of claim 1, wherein increasing the congestion window includes increasing an initial window size of the transport protocol.

5. The media of claim 1, further comprising sending one or more packets of the transport protocol a threshold number of times.

6. The media of claim 5, wherein the threshold number of times is two.

7. The media of claim 1, wherein the search query is contained in a first packet of a handshake of the transport protocol.

8. The media of claim 1, wherein the response includes a response to the search query and forward error correction data.

9. The media of claim 1, wherein the response related to the search query is received directly from the search engine.

10. The media of claim 1, wherein the response related to the search query is received from the closest intermediate server.

11. Computer-readable media having computer-executable instructions embodied thereon that, when executed, perform a method of reducing search-response latency, the method comprising:
receiving a search query from a client computing device (“client”);
sending the search query to a search engine utilizing a first transport protocol;
sending a number of packets to the client utilizing a second transport protocol;
utilizing said number of packets to open a congestion window of the second transport protocol;
receiving a response related to the search query from the search engine; and
sending the response to the client.

12. The media of claim 11, wherein the search query from the client computing device is received in a first packet of a handshake of a second transport protocol.

13. The media of claim 11, wherein the response related to the search query is received from the search engine in a packet of a handshake of the first transport protocol.

14. The media of claim 13, further comprising receiving the response related to the search query utilizing the first transport protocol a first threshold number of times.

15. The media of claim 14, further comprising sending the response related to the search query utilizing the second transport protocol a second threshold number of times.

16. The media of claim 15, wherein the first threshold and the second threshold are two.

17. The media of claim 11, wherein the response includes data related to the search query and forward error correction data.

18. Computer-readable media having computer-executable instructions embodied thereon that, when executed, perform a method of reducing query-response latency, the method comprising:
determining a closest intermediate server, which is positioned between a client computing device (“client”) and a destination server;
increasing an initial window size of a transport protocol from a first size to a second size;
sending a query to the closest intermediate server, wherein said query is sent a threshold number of times;
receiving a plurality of packets from the closest intermediate server;
utilizing said plurality of packets to open a sending window of the transport protocol; and
receiving a response related to the query from the intermediate server, said response including data related to the query and forward error correction data.

19. The media of claim 18, wherein determining the closest intermediate server includes requesting an address of a closest intermediate server from a domain name service utilizing a geographic-based proximity algorithm.

20. The media of claim 18, wherein said first size is two maximum segment sizes and said second size is eight maximum segment sizes.
